(19) United States
(12) Patent Application Publication
(10) Pub. No.: US 2007/0085026 A1
(43) Pub. Date: Apr. 19, 2007

(54) Invisible eyemark and method for orienting squeeze tube

(76) Inventors: Neal E. Langseder, New Canaan, CT (US); Edward Wiegand, Philadelphia, PA (US)

Correspondence Address: Licata & Tyrrell P.C., 66 E. Main Street, Marlton, NJ, 08053, US

(21) Appl. No.: 11/250,280

(22) Filed: Oct. 14, 2005

(51) Int. Cl. F21K 2/00

(52) U.S. Cl. 250/462.1

(57) ABSTRACT

The present invention is an invisible eyemark for orienting squeeze tubes during manufacture. The invisible eyemark is composed of a dye that absorbs electromagnetic wavelengths outside of the visible spectrum and is therefore invisible to the human eye. The invisible eyemark is an improvement over the art, as it does not detract from tube decorations or product labels.

### BACKGROUND OF THE INVENTION

Various products such as personal care or cosmetic products (e.g., toothpaste and lotions) are sold to consumers in flexible plastic tubes. Squeezable tube-shaped containers have a tubular body with one end heat-sealed along a straight line seam. For instance, see U.S. Pat. Nos. 5,632,951; 3,197,532; 5,908,124; and 5,213,235, which disclose the use of blow molding techniques for forming tube-shaped containers. In addition, U.S. Pat. No. 5,908,124 discloses the formation of an integral twist-off closure to eliminate the need for providing a separately manufactured closure. Also see U.S. Pat. No. 4,540,542 which discloses a method of making an extrusion blow molded container with an integral, removable closure and U.S. Pat. No. 5,141,136 which discloses a squeeze bottle having dual openings.

During manufacture of such tubes an eyemark is located near the edge of the seal to allow for proper tube orientation during end sealing. Eyemarks are typically opaque, visible, black marks that are distinct from tube decoration or product labels and can be readily detected by sensors.

Registration marks are disclosed for use in manufacturing disposable absorbent articles in U.S. Pat. No. 6,739,509. This patent teaches an optical or ultraviolet brightener to encode bits of a registration mark on diapers, training pants, feminine care products, incontinence products, and the like.

Similarly, U.S. Pat. No. 6,358,353 teaches a roll fed labeling system and associated label. The label

### BACKGROUND OF THE INVENTION

Various products such as personal care or cosmetic products (e.g., toothpaste and lotions) are sold to consumers in flexible plastic tubes. Squeezable tube-shaped containers have a tubular body with one end heat-sealed along a straight line seam. For instance, see U.S. Pat. Nos. 5,632,951; 3,197,532; 5,908,124; and 5,213,235, which disclose the use of blow molding techniques for forming tube-shaped containers. In addition, U.S. Pat. No. 5,908,124 discloses the formation of an integral twist-off closure to eliminate the need for providing a separately manufactured closure. Also see U.S. Pat. No. 4,540,542 which discloses a method of making an extrusion blow molded container with an integral, removable closure and U.S. Pat. No. 5,141,136 which discloses a squeeze bottle having dual openings.

During manufacture of such tubes an eyemark is located near the edge of the seal to allow for proper tube orientation during end sealing. Eyemarks are typically opaque, visible, black marks that are distinct from tube decoration or product labels and can be readily detected by sensors.

Registration marks are disclosed for use in manufacturing disposable absorbent articles in U.S. Pat. No. 6,739,509. This patent teaches an optical or ultraviolet brightener to encode bits of a registration mark on diapers, training pants, feminine care products, incontinence products, and the like.

Similarly, U.S. Pat. No. 6,358,353 teaches a roll fed labeling system and associated label. The label includes a triggering mark formed of luminophor ink, i.e., containing a fluorescent optical brightening agent, that reflects visible light when irradiated with UV light. A modulated UV light is directed at the label and the modulated reflected visible light is detected and used to trigger a cutting mechanism to separate a single label from the remainder of the roll.

### SUMMARY OF THE INVENTION

The present invention is an invisible eyemark for orientation of a squeeze tube during manufacture. Advantageously, the instant eyemark is a dye which absorbs light outside the visible spectrum and therefore does not detract from the product label. A squeeze tube containing an invisible eyemark and a method for orienting a squeeze tube during manufacture using an invisible eyemark are also provided.

### DETAILED DESCRIPTION OF THE INVENTION

As used in the context of the instant invention, a squeeze tube is a flexible, cylindrical package made from metal, plastic or laminate with one open end and one closed end. The package is filled through the open end with a machine designed for filling tubes. Once filled, the tube is sealed at one end by heating or alternatively folding and clamping. The result is a package with a cylindrical, open end and a flattened, closed end, wherein the flattened, closed end defines the front and back panels of the squeeze tube.

To orient the squeeze tube for proper seal, and decoration or product label placement, an eyemark is typically printed on the end of the tube which is to be sealed. The eyemark is used by the tube filling machine to locate the back panel before the seal is made. The filling machine uses an optical sensor to find the eyemark, the machine then rotates the tube to place the eyemark at a predetermined location in the area to be sealed, and subsequently seals the tube. The eyemark, typically located at the center of the seal on the back panel, is used for proper placement of the tube decoration or product label relative to the front and back panels of the tube.

While eyemarks are essential to the process of sealing and labeling of squeeze tubes, visible eyemarks can detract from the tube decoration or product label. Accordingly, the instant invention is an invisible eyemark which absorbs light wavelengths located outside of the visible spectrum. An eyemark, as used in the context of the instant invention, is an art-recognized term describing a small rectangular printing area usually located near the edge of a web (e.g., in the instant case a tube) or design, for use in activating an automatic electronic position regulator for controlling register or the printed design during the manufacturing process. For the purposes of the instant invention, an eyemark is distinct from a registration mark, which is known in the art as symbols attached to original copy prior to photography, used for positioning films in register, or registering two or more colors when printing.

The instant eyemark is said to be invisible in that it is composed of a dye, which absorbs wavelengths located outside of the visible light spectrum, and therefore is not visible when exposed to wavelengths of the visible light spectrum. As is well-known to those of skill in the art, the visible light spectrum is a narrow range of frequencies of the electromagnetic spectrum which stimulate the retina of the human eye. The visible light spectrum encompasses wavelengths in the range of approximately 700 nanometers (nm) to approximately 400 nm. This narrow band of visible light is also known as ROYGBIV. Thus, a dye which absorbs wavelengths located outside of the visible light spectrum is one which absorbs wavelengths of more than 700 nm or less than 400 nm in the electromagnetic spectrum.

In particular embodiments, wavelengths located outside of the visible light spectrum encompass wavelengths located in the infrared and ultraviolet regions of the electromagnetic spectrum. Infrared wavelengths generally range from approximately 1.0 millimeter (mm) to approximately 700 nm, whereas ultraviolet wavelengths encompass a region of the electromagnetic spectrum in the range of approximately 375 nm to approximately 12.5 nm. Accordingly, in the context of this embodiment, an eyemark is composed of a dye which absorbs wavelengths located in the infrared and ultraviolet regions of the electromagnetic spectrum.

As used herein, an eyemark dye is an organic compound that is colorless or undetectable until the compound absorbs wavelengths outside the visible light spectrum. Upon absorption of said wavelengths, the dye is readily visualized or detected. When the source of the wavelength is removed, the dye of invention reverts to being colorless or undetectable.

In one embodiment of the instant invention, the eyemark dye absorbs infrared wavelengths. Dyes of this type are typically referred to as thermochromatic. Thermochromatic dyes of use in accordance with the instant invention are colorless at room temperature and through the application of infrared light, emit light in the visible wavelength. Examples of thermochromatic dyes are disclosed in U.S. Pat. Nos. 4,028,118; 4,567,019; and 4,421,560, incorporated herein by reference, and are readily available from SICPA (Brooklyn Park, Minn.).

In another embodiment, the dye of the instant eyemark absorbs ultraviolet light. Dyes of this type are generally referred to as photochromatic. Photochromatic dyes of particular use in accordance with the instant invention are colorless, and upon exposure to ultraviolet radiation, emit light in the visible wavelength. Examples of suitable photochromatic dyes can be readily obtained from United Mineral & Chemical Corporation (Lyndhurst, N.J.) and Graphic Management Specialty Products (i.e., Chamelacolors; Green Bay, Wis.). Other suitable photochromatic dyes are well-known to the skilled artisan as such dyes are routinely employed in producing a photosensitive eyeglass lens.

In certain embodiments, the instant eyemark dye is an optical brightener. An optical brightener is a fluorescent dye, which absorbs wavelengths from the ultraviolet region of the electromagnetic spectrum (e.g., long-wave fluorescent ultraviolet or black light) and emits energy in the blue region of the visible spectrum. Optical brighteners are typically used as additives to washing powders, detergents, and in paper manufacture to hide yellow and brown tones, making the treated material appear whiter. Suitable optical brighteners which can be used in accordance with the instant invention include, but are not limited to, 4,4′-diaminostilbene-2,2-disulfonic acid; coumarin derivatives such as 4-methyl-7-diethylaminocoumarin; mixtures of 4,4′-bis-(4-sulphophenylamino-6-di-ethanolamino-2-sym-triazinylamino)-stilbene-2,2′-disulphonic acid, 4,4′-bis-(4-sulphophenylamino-6-diisopropanolamino-2-sym-triazinylamino) -stilbene-2,2′-disulphonic acid and the corresponding asymmetrical compound, in triethanolamine salt form (see WO 00/46336); mixtures of distilbene-disulphonic acids and 4,4′-bistriazinylamino-stilbene-2,2′-disulphonic acids (see U.S. Pat. No. 5,518,657); and mixtures of anilino-substituted 4,4′-bis-triazinylamino-stilbene disulphonic acids (see U.S. Pat. No. 6,890,454).

Advantageously, an invisible eyemark of the instant invention can be used for orienting a squeeze tube during manufacture (i.e., heading, capping, labeling, filling, or sealing) without detracting from the tube decoration or product label of the resulting product. The invisible eyemark dye can be printed directly onto the squeeze tube surface or label and can be a component of an ink or varnish. In particular embodiments, the eyemark dye is applied to the squeeze tube label in a varnish. As such, the eyemark is printed onto the squeeze tube label using any standard printing technique suitable for the dye and label material employed. Such printing techniques are well-known in the art and include, but not limited to, offset, letter press, gravure, silk screen, flexographic, or digital. As the instant eyemark is invisible, one of skill in the art will appreciate that the eyemark can be printed anywhere on the tube surface so long as it can be detected and used as a reference point for demarcating the front and back of the tube and for proper placement of the tube decoration or product label relative to the front and back panels of the tube. It will also be appreciated by the skilled artisan that the instant invisible eyemark can be used to identify, orient or register other features of the tube relative to one another.

It is contemplated that the presence of the invisible eyemark can be detected by measuring the reflection or absorption spectrum of the eyemark. For example, when the eyemark dye absorbs a wavelength outside of the visible spectrum and does not emit visible light in response, reflection measurements can be used to detect the absorption event. To facilitate detection, particular embodiments of the instant invention encompass the use of a dye which absorbs light outside of the visible spectrum and in response emits light in the visible spectrum. For sensing wavelengths below 1100 nm, a photoconductive cell or a silicon-based detector is appropriate. For ultraviolet to near infrared wavelengths, photodiodes are suitable. These types of sensors are well-known to the skilled artisan and commercially available (see, e.g., Rockwell Automation's Allen-Bradley sensors).

The present invisible eyemark finds application in the manufacture of squeeze tubes for a variety of consumable or purchased goods or products including consumable products such as personal care products (e.g., soaps, shampoos, make-up, insect repellents, and the like); first aid products (e.g., ointments, sunscreens, and the like); cleaners (e.g., detergents and cleaning solutions); paints; and foodstuffs (e.g., yogurt, cheese-like products, jelly, and the like).

Because visible eyemarks are known to detract from the aesthetics of the final product, many manufacturers trim off a portion of the sealed end to remove the eyemark. This results in additional waste material. Thus, the instant invisible eyemark is a significant improvement in the manufacture of squeeze tubes as additional waste material is not involved and the instant invisible eyemark does not detract from the tube decoration, product label, bar codes, etc.

What is claimed is:

1. An invisible eyemark for orienting a squeeze tube during manufacture comprising a dye which absorbs wavelengths outside the visible light spectrum.

2. A method for orienting a squeeze tube during manufacture comprising printing the invisible eyemark of claim 1 on the squeeze tube so that the squeeze tube can be oriented during manufacture.

3. A squeeze tube comprising an eyemark which is printed on the squeeze tube so that the squeeze tube can be oriented during manufacture, wherein the eyemark absorbs light outside the visible spectrum.
